(19) United States
(12) Patent Application Publication
(10) Pub. No.: US 2016/0255496 A1
(43) Pub. Date: Sep. 1, 2016

(54) METHOD AND SERVER FOR CONFIGURING A MOBILE TERMINAL AND PORTABLE ELECTRONIC DEVICE

(71) Applicant: SONY CORPORATION, Tokyo (JP)

(72) Inventor: Jonas Andersson, Lund (SE)

(73) Assignee: SONY CORPORATION, Tokyo (JP)

(21) Appl. No.: 14/423,789

(22) PCT Filed: Mar. 27, 2014
(86) PCT No.: PCT/IB2014/060195

§ 371 Date: Feb. 25, 2015

(51) Int. Cl. H04W 8/24; G06F 17/22

(52) U.S. Cl. CPC H04W 8/245; G06F 17/227; G06F 17/2288; G06F 17/2247

(57) ABSTRACT

A plurality of portable electronic devices monitors a user-initiated re-writing of a Cascading Style Sheets, CSS, source and/or of at least one CSS variable. A server crowdsources information on the user-initiated re-writing from the plurality of portable electronic devices through a cellular communication network. The server processes the crowdsourced information on the user-initiated re-writing to determine CSS to be used by the mobile terminal. The server outputs information on the determined CSS to configure the mobile terminal.

### TECHNICAL FIELD

Embodiments of the invention relate to mobile terminals. Embodiments of the invention relate in particular to methods and devices for automatically configuring mobile terminals and to a communication system.

### BACKGROUND ART

Mobile voice and data communication continues to evidence significant growth. Modern mobile terminals of a communication network, e.g. smartphones, have advanced processing capabilities. The mobile terminals can run a wide variety of applications. These applications include social networks, e-mail services, update clients such as news update centers or weather forecasts, without being limited thereto.

Web applications may be used to provide various services and features in a mobile terminal of a cellular communication network. The web application may be stored in a wide area network, e.g. the internet. The mobile terminal may retrieve the web application for local execution through the cellular communication network. The web application may also be executed on a server in the internet, i.e., remotely from the mobile terminal, and the mobile terminal may retrieve data through the cellular communication network in accordance with the execution of the web application.

With increasing popularity of mobile voice and data services, the types of mobile terminals attached to the cellular communication network for execution of a web application have become more diverse. The mobile terminals may have significantly varying processing capabilities, sound interfaces, optical interfaces, or bandwidths, for example. This makes it increasingly challenging to provide web applications suitable for a wide variety of devices. When a user is allowed to make some adjustments to local device settings of his mobile terminal, the mobile terminal may be optimized to a certain extent for execution of a particular web application, for example. However, the need to make many adjustments on the mobile terminal may negatively affect the user experience.

Similar problems exist when a user starts using a new mobile terminal and is faced with the task of identifying suitable device settings starting from pre-defined default settings which may be applicable to a large number of countries and/or hardware configurations and which may not take into account the communication bandwidth or other hardware constraints in the mobile terminal. The large number of adjustments which need to be made to the device settings may be cumbersome to some users.

### SUMMARY

There is a continued need in the art for devices and methods which mitigate the problems associated with adjustments of device settings of a mobile terminal. There is in particular a need for methods and devices in which a suitable configuration of a mobile terminal may be determined automatically to configure the mobile terminal accordingly.

According to embodiments, dynamic Cascading Style Sheets, CSS, are used on a plurality of portable electronic devices. The portable electronic devices allow the user to initiate a re-writing of a CSS source and/or of CSS variables. Information on the user-initiated re-writing of the CSS source and/or CSS variables is crowdsourced. The CSS which are to be used by a mobile terminal can be determined automatically from the crowdsourced information on the user-initiated re-writing.

Embodiments of the invention use dynamic CSS, DCSS, which support variables in the CSS and dynamic re-writing of the CSS source. By crowdsourcing individual dynamic re-writing of the CSS source from plural portable electronic devices the most common CSS can be found, which is considered to be suitable for the respective device type. It is also possible that more than one suitable CSS is identified. By allowing users to adopt the CSS locally and use machine learning or agent-based learning centrally using individually adopted CSS as input, suitable or even optimum CSS can be created for each device type. A mobile terminal can be inserted into the system as a new device and can be configured based on the crowd-sourced information on the dynamic re-writing of the CSS source and CSS variables.

A method of configuring a mobile terminal according to an embodiment comprises monitoring, by each one of a plurality of portable electronic devices, a user-initiated re-writing of a Cascading Style Sheets, CSS, source and/or of at least one CSS variable. A server crowdsources information on the user-initiated re-writing from the plurality of portable electronic devices through a cellular communication network. The server processes the crowdsourced information on the user-initiated re-writing to determine CSS to be used by the mobile terminal. The server outputs information on the determined CSS to configure the mobile terminal.

The mobile terminal may be included in the plurality of portable electronic devices. I.e., the mobile terminal may also report information on a user-initiated re-writing of the CSS source and/or the CSS variables to the server and may be automatically reconfigured by the server based on the dynamic changes made to the CSS source and CSS variables on other portable electronic devices.

The mobile terminal may be different from each electronic device of the plurality of electronic devices, while having a hardware configuration similar or identical to some of the electronic devices. I.e., the mobile terminal may be automatically configured based on the dynamic changes made to the CSS source and CSS variables on other portable electronic devices.

The mobile terminal and the plurality of electronic devices may respectively be configured to communicate over a cellular communication network. The mobile terminal and the plurality of electronic devices may respectively be user equipments of a long term evolution, LTE, cellular communication network.

The server may apply one or several filters when processing the crowdsources information. In particular, the server may take into account hardware configurations, locations, or time of usage of the various portable electronic devices when determining the CSS to be used by the mobile terminal.

The method may comprise identifying a sub-set of portable electronic devices in the plurality of portable electronic devices by comparing at least hardware configurations of the plurality of portable electronic devices to a hardware configuration of the mobile terminal. The server may use only the crowdsourced information on the user-initiated re-writing from the sub-set of portable electronic devices to determine the CSS to be used by the mobile terminal. This allows the CSS for the mobile terminal to be configured taking into account the hardware configuration of the mobile terminal. For illustration, for a mobile terminal configured as a mobile phone, the crowdsourced information from portable electronic devices which also are mobile phones may be weighted more strongly than the crowd-sourced information from other portable electronic devices having significantly different hardware configurations, such as portable image frames or portable music players.

Identifying the sub-set of portable electronic devices may comprise comparing a processor of the plurality of portable electronic devices to a processor of the mobile terminal. This may be of particular relevance when the CSS is to be used for applications which require a large amount of computational resources and/or for determining whether a web application is to be executed locally at the mobile terminal or remotely from the mobile terminal, for example.

Alternatively or additionally, identifying the sub-set of portable electronic devices may comprise comparing a memory of the plurality of portable electronic device to a memory of the mobile terminal. This may be of particular relevance when the CSS is to be used for applications which require a large amount of memory resources.

Alternatively or additionally, identifying the sub-set of portable electronic devices may comprise comparing a wireless interface configuration of the plurality of portable electronic devices to a wireless interface configuration of the mobile terminal. This may be of particular relevance when the CSS is to be used for applications in which bandwidth matters, e.g. streaming applications, media rendering, or similar.

The server may respectively retrieve information on the hardware configurations of the portable electronic devices from the portable electronic devices when crowdsourcing the information on the dynamic re-writing of the DCSS. The server may alternatively access a database which includes, for a plurality of portable electronic device types, information on the hardware configuration of the respective device type. The WURFL database, which is a Device Description Repository (DDR), is exemplary for such a database.

Alternatively or additionally, identifying the sub-set of portable electronic devices may comprise a location-based filtering. This allows the configuration of the CSS to be automatically adjusted to the geographical area in which the mobile terminal is to be used. For illustration, language setting and font set preferences may vary depending on country, and the adaptation of the CSS made by users of portable electronic devices in one country may be taken into account for determining the CSS to be used by the mobile terminal in the same country.

Alternatively or additionally, identifying the sub-set of portable electronic devices may comprise a filtering in dependence on a number of user input actions which cause the user-initiated re-writing of the CSS source and/or of the at least one CSS variable. The CSS adopted on each portable electronic device of the plurality of portable electronic devices may depend on whether the user is still in the initial configuration phase or whether the user of the portable electronic device has completed the initial configuration phase. Information on the number of user input actions which cause the user-initiated re-writing may also be crowdsourced by the server. The number of user input actions per time or the number of user input actions accumulated since the first start-up of the device is indicative of the completion of the configuration phase. This information may be taken into account when determining the CSS for the mobile terminal. For illustration, for a mobile terminal which enters operation for the first time, a CSS may be suitable which is obtained from the crowdsourced information which represents changes made to the CSS of the plurality of portable electronic devices in their respective initial configuration phase.

Each portable electronic device of the plurality of portable electronic devices may monitor user input actions received at a user interface from a user which cause the CSS source to be re-written. Information on the change made to the CSS source or information on the re-written CSS source may be provided to the server.

The server may generate at least one message based on the determined CSS which is to be used by the mobile terminal. The server may transmit the at least one message to at least one of the mobile terminal or a web server for executing a web application using the determined CSS. This allows the mobile terminal to be configured for using the determined CSS. The message may be transmitted over the cellular communication network.

The server may use the crowdsourced information on the user-initiated re-writing as input for a machine learning to determine the CSS to be used by the mobile terminal.

The server may use the crowdsourced information on the user-initiated re-writing as input for an agent-based learning to determine the CSS to be used by the mobile terminal.

According to an embodiment, a portable electronic device is provided. The portable electronic device comprises a user interface. The portable electronic device comprises a communication interface configured for communication with a cellular communication network. The portable electronic device comprises a processor coupled to the user interface and the communication interface. The processor is configured to perform a re-writing of a Cascading Style Sheets, CSS, source and/or of at least one CSS variable in accordance with a user input action detected by the user interface. The processor is configured to control the communication interface to report information on the user-initiated re-writing to a server over the cellular communication network.

Such a portable electronic device supports a process of automatically configuring mobile terminals by allowing the server to crowdsource information on a dynamic rewriting of the CSS source and/or the at least one CSS variable.

The processor may be configured to monitor the re-writing of the CSS source and/or of the at least one CSS variable throughout a time interval prior to reporting the information to the server. The processor may be configured to aggregate and locally process changes in the CSS source and/or of at least one CSS variable before the information is reported to the server. For illustration, changes to the CSS source and/or of a CSS variable which are undone by the user at the portable electronic device may be discarded by the portable electronic device and may not be reported to the server. Transient modifications of the CSS source and/or of the CSS variables may thereby be filtered out.

The processor may be configured to report information on a hardware configuration to the server when reporting the information on the user-initiated re-writing.

The processor may be configured to report location information for the portable electronic device to the server when reporting the information on the user-initiated re-writing.

The processor may be configured to report where in a configuration phase the portable electronic device is. The processor may be configured to generate an indicator for a number of user input actions throughout a time interval which cause the CSS source and/or the at least one CSS variable to be re-written, and to control the communication interface such that the information includes the indicator.

The processor may be configured to use the CSS source and the at least one CSS variable for controlling the user interface and/or the communication interface for web application execution.

The portable electronic device may be configured to receive information on a new CSS to be used by the portable electronic device from the server over the communication interface. This allows the portable electronic device to be reconfigured by the server in accordance with the dynamic re-writing of the CSS source and CSS variables performed at various other portable electronic devices.

A server according to an embodiment comprises an interface configured for communication with a cellular communication network, and a processing device coupled to the interface. The processing device is configured to crowdsource information on a user-initiated re-writing of a Cascading Style Sheets, CSS, source and/or of at least one CSS variable from the plurality of portable electronic devices connected to the cellular communication network. The processing device is configured to process the crowdsourced information on the user-initiated re-writing to determine CSS to be used by a mobile terminal. The processing device is configured to provide information on the determined CSS to a mobile terminal through the interface to configure the mobile terminal.

Such a server can automatically determine a CSS suitable for a mobile terminal by crowdsourcing information on a dynamic re-writing of CSS source and/or CSS variables at a plurality of portable electronic devices.

The processing device may be configured to apply one or several filters when processing the crowdsourced information. In particular, the server may take into account hardware configurations, locations, or time of usage of the various portable electronic devices when determining the CSS to be used by the mobile terminal.

The processing device may be configured to identify a sub-set of portable electronic devices in the plurality of portable electronic devices by comparing at least hardware configurations of the plurality of portable electronic devices to a hardware configuration of the mobile terminal. The processing device may be configured to use only the crowdsourced information on the user-initiated re-writing from the sub-set of portable electronic devices to determine the CSS to be used by the mobile terminal.

The processing device may be configured to compare at least hardware configurations of the plurality of portable electronic devices to a hardware configuration of the mobile terminal.

The processing device may be configured to compare a processor of the plurality of portable electronic devices to a processor of the mobile terminal to identify the sub-set of portable electronic devices.

Alternatively or additionally, the processing device may be configured to compare a memory of the plurality of portable electronic devices to a memory of the mobile terminal to identify the sub-set of portable electronic devices.

Alternatively or additionally, the processing device may be configured to compare a wireless interface configuration of the plurality of portable electronic devices to a wireless interface configuration of the mobile terminal to identify the sub-set of portable electronic devices.

The server may respectively be configured to retrieve information on the hardware configurations of the portable electronic devices from the portable electronic devices when crowdsourcing the information on the dynamic re-writing of the DCSS. The server may alternatively or additionally be configured to access a database which includes, for a plurality of portable electronic device types, information on the hardware configuration of the respective device type.

Alternatively or additionally, the processing device may be configured to perform a location-based filtering to identify the sub-set of portable electronic devices.

Alternatively or additionally, the processing device may be configured to perform a filtering which takes into account where in a configuration phase the respective portable electronic devices are to identify the sub-set of portable electronic devices. The processing device may be configured to perform the filtering in dependence on a number of user input actions which cause the user-initiated re-writing of the CSS source and/or of the at least one CSS variable.

The processing device may be configured to control the communication interface to generate at least one message based on the determined CSS which is to be used by the mobile terminal. The server may be configured to transmit the at least one message to at least one of the mobile terminal or a web server for executing a web application using the determined CSS.

The processing device may use machine learning or agent-based learning to determine the CSS to be used by the mobile terminal.

A communication system according to an embodiment comprises a plurality of portable electronic devices according to an embodiment and a server according to an embodiment. The communication system may further comprise the mobile terminal for which the CSS is determined by the server.

Devices and methods according to embodiments allow a CSS which shall be used by a mobile terminal to be determined automatically. The CSS can be adjusted in accordance with the dynamic re-writing of CSS source or CSS variables which is performed at a plurality of portable electronic devices which have similar construction and/or are located in the same area and/or are at the same state in the configuration phase as the mobile terminal.

### BRIEF DESCRIPTION OF DRAWINGS

Embodiments of the invention will be described with reference to the accompanying drawings in which the same or similar reference numerals designate the same or similar elements.

FIG. 1 is a schematic view of a communication system according to an embodiment.

FIG. 2 is a block diagram of a portable electronic device according to an embodiment.

FIG. 3 is a flow chart of a method according to an embodiment.

FIG. 4 is a flow chart of a method according to an embodiment.

FIG. 5 is a flow chart of a method according to an embodiment.

FIG. 6 illustrates indicators for a state in a configuration phase which may be used in methods and devices according to embodiments.

FIG. 7 illustrates indicators for a state in a configuration phase which may be used in methods and devices according to embodiments.

FIG. 9 is a functional block representation of a server according to an embodiment.

### DESCRIPTION OF EMBODIMENTS

Exemplary embodiments of the invention will be described with reference to the drawings. While some embodiments will be described in the context of specific fields of application, e.g. in the context of exemplary radio access technologies, the embodiments are not limited to this field of application. The features of the various embodiments may be combined with each other unless specifically stated otherwise.

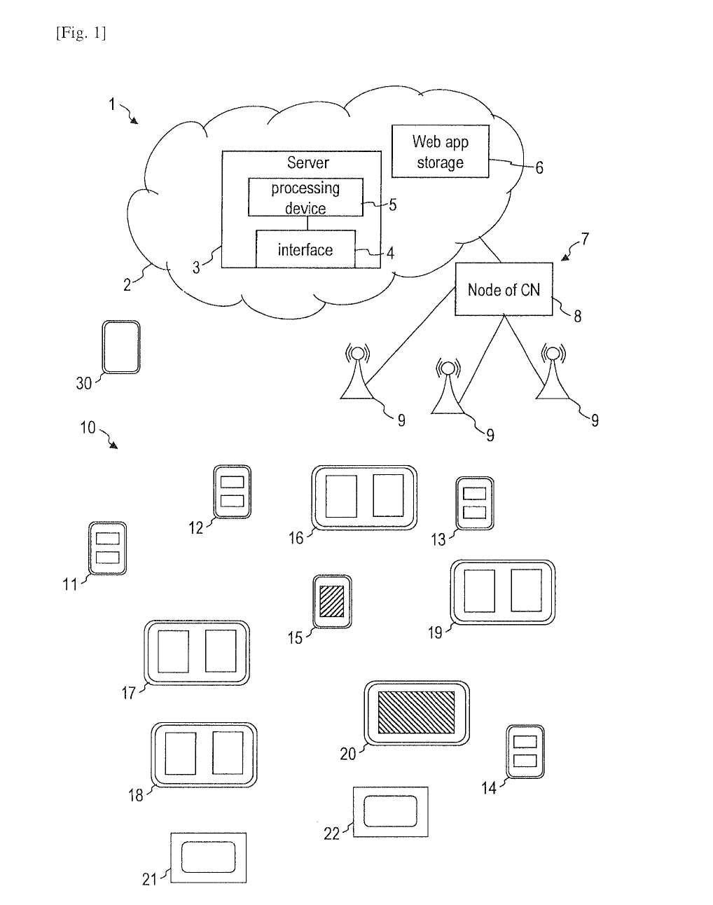

FIG. 1 is a schematic view of a communication system 1 according to an embodiment. The communication system 1 comprises a server 3 and a cellular communication network 7. The server 3 may be connected to other servers in a wide area network 2, e.g. the internet. A storage 6 for web applications may also be provided in the wide area network 2.

The cellular communication network 7 has a radio access network (RAN). The radio access network includes a plurality of base stations 9. The base stations 9 may be operatively coupled to other nodes 8 which may be provided in the radio access network or in a core network (CN) of the cellular communication network 7. The specific configuration of the cellular communication network 7, of the base stations 9 and of the nodes 8 depends on the communication standard. For illustration, the cellular communication network 7 may be a Global System for Mobile Communications (GSM) network. In this case, the RAN is a GSM EDGE Radio Access Network (GERAN). The cellular communication network 7 may be a Universal Mobile Telecommunications System (UMTS) network. In this case, the RAN is a UMTS Terrestrial Radio Access Network (UTRAN), with the base stations 9 respectively being a NodeB controlled by a Radio Network Controller (RNC). The cellular communication network 7 may be a Long Term Evolution (LTE) network. In this case, the RAN is an evolved UTRAN (eUTRAN), with the base stations 9 respectively being an evolved Node B (eNodeB), and the node 8 being a Mobility Management Entity (MME) and/or Serving Gateway (S-GW) in the core network.

A plurality of portable electronic devices 11-22 may be configured for communication with the cellular communication network 7. As will be explained in more detail below, dynamic Cascading Style Sheets, CSS, are deployed to the plurality of portable electronic devices 11-22. As used herein, the term dynamic CSS (DCSS) refers to CSS in which the CSS source and/or CSS variables are configured such that they can be re-written. The dynamic re-writing of the CSS source and/or CSS variables can occur in response to a user input action at the respective portable electronic device 11-22, when a user changes setting of the respective portable electronic device, for example. The server 3 crowdsources information on the dynamic re-writing of the CSS source and/or the CSS variables from the plurality of portable electronic devices 11-22. The server 3 processes the crowdsourced information to determine CSS which are to be used by a mobile terminal 30. The mobile terminal 30 can be automatically configured with the determined CSS.

It is to be understood that not all portable electronic devices which can attach to the cellular communication network 7 need to support the crowdsourcing of user-initiated re-writing of DCSS. The term “plurality of portable electronic devices” as used herein refers to devices attached to the cellular communication network 7 from which the server 3 crowdsources information on the user-initiated re-writing of the CSS source and/or CSS variables which occurs at the respective portable electronic device. For illustration, in some portable electronic devices, the user may activate a setting which prevents the portable electronic device from participating in the crowdsourcing scheme described herein. In this case, the server does not crowdsource information on a rewriting of the CSS source or of the CSS variables from the respective portable electronic device.

In order to configure the mobile terminal 30 with a CSS which is tailored for the respective mobile terminal 30, the server 3 may retrieve information on a hardware configuration of the mobile terminal 30. The server 3 may use a database provided in the wide area network 2 to retrieve hardware information for the mobile terminal 30. The server may use information transmitted from the mobile terminal 30 which identifies the manufacturer and model of the mobile terminal 30 or other data input which allows the server 3 to retrieve information on the hardware configuration of the mobile terminal 30 from the database. The database may be a Device Description Repository (DDR). The WURFL database is one example for such a database.

The plurality of portable electronic devices 11-22 may have a variety of different hardware configurations, may be located in a variety of different countries, and/or may have been in use for different time periods. The server 3 may utilize information on the hardware configurations of the portable electronic devices 11-22 retrieved from the DDR and location information retrieved from the portable electronic devices or a node in the CN 7. The server 3 may identify a CSS for the mobile terminal 30 based on the crowdsourced information, and may take into account whether the respective portable electronic devices 11-22 are located in the same area, e.g. the same country, as the mobile terminal 10 and/or whether the respective portable electronic devices 11-22 are similar or identical in hardware configuration to the mobile terminal 30.

For illustration, portable electronic devices 11-15 may have a processor, memory, display, sound interface and/or wireless interface which are identical or at least similar to that of the mobile terminal 30. The portable electronic devices 16-20 may have a processor, memory, display, sound interface and/or wireless interface which are different from that of the mobile terminal 30. Similarly, yet other portable electronic devices 21, 22 may provide a communication bandwidth which is much smaller than that of the mobile terminal 30. When determining the CSS to be used by the mobile terminal 30, the server 3 may weight information on the re-writing of the CSS source and CSS variables retrieved from portable electronic devices 11-15 more strongly than information retrieved from the portable electronic devices 16-22. In some implementations, only the information retrieved from the portable electronic devices 11-15 which have the same or essentially the same hardware configuration as the mobile terminal 30 may be used to identify the CSS to be used by the mobile terminal 30.

For further illustration, the location of the portable electronic devices 11-22 may also be taken into account when determining the CSS to be used by the mobile terminal 30. In some implementations, only the information retrieved from the portable electronic devices which are located in the same country as the mobile terminal 30 may be used to identify the CSS to be used by the mobile terminal 30.

A consistent pattern of changes which are made to the CSS source and the CSS variables by user input action will emerge. Typical examples for such user input actions include preference settings whether web application are executed locally or remotely, quality of video or audio streams retrieved from the internet, display or sound interface setting, or other settings. The portable electronic device automatically adopts the CSS source and the CSS variables, if applicable, to the changes made by the user input action to the configuration of the portable electronic device. By crowdsourcing information on the re-writing of the CSS source and the CSS variables which is performed at the plurality of portable electronic devices, the consistent pattern of changes to the CSS source and CSS variables which define good or even optimum settings for the respective can be detected.

Not all of the portable electronic devices will undergo the same user-initiated changes in CSS source and CSS variables. For illustration, several portable electronic devices 11-15 having the same hardware configuration and located in the same region may still be subject to different user-initiated adoptions of the CSS. As schematically illustrated in FIG. 1, portable electronic devices 11-14 may undergo a user-initiated rewriting of the CSS source and CSS variables which is identical or at least similar among the portable electronic devices 11-14. One or several other portable electronic devices 15 may receive user input actions which change the device settings in different ways. This results in a re-writing of the CSS source and CSS variables at the portable electronic device 15 which is different from the re-writing of the CSS source and CSS variables at the portable electronic devices 11-14.

Similarly, portable electronic devices 16-19 may receive user input actions which lead to a consistent adaptation of the CSS source and CSS variables, whereas the portable electronic device 20 having the same hardware configuration may receive user input actions which lead to a different adaptation of the CSS source and CSS variables.

By crowdsourcing information on the changes made to the CSS source and CSS variables at the portable electronic devices 11-22, the server 3 can identify changes made to the CSS source and CSS variables which were adopted consistently for a significant fraction of portable electronic devices. For illustration, in a simple implementation, the server 3 can crowdsource the information on the user-initiated rewriting of the CSS source and CSS variables via an interface 4. The interface 4 may be connected to other servers of the wide area network 2, which allows the server 3 to crowdsource the information on the user-initiated re-writing of the CSS source and CSS variables through the cellular communication network. A processing device 5 of the server 3 may process the crowdsourced information on user-initiated re-writing of the CSS source and CSS variables to identify changes to the CSS which are made consistently at various portable electronic devices, depending on the hardware configurations, the locations, or other parameters of the respective portable electronic devices.

The server 3 can be configured in various ways to identify one or several possible CSS to be used by the mobile terminal 30. In one implementation, the processing device 5 may be configured to identify changes of the CSS source and the CSS variables which were made in response to user actions in at least a pre-defined fraction of the crowdsources portable electronic devices 11-15 of the same device type as the mobile terminal 30.

The server 3 can employ machine learning or agent-based learning to identify the CSS which may be suitable for the mobile terminal 30. The crowdsourced information obtained from the plurality of portable electronic devices 11-22, optionally in combination with information on the hardware configuration, location, state in configuration phase or other parameters, may be used as input for the machine learning or the agent-based learning.

The server 3 may output information on the CSS which has been determined to be a suitable and, ideally, optimum CSS for the mobile terminal 30. The server 3 may output the information to the mobile terminal 30 through the cellular communication network 30. For illustration, the server 3 may generate one or several messages which define a delta, i.e. changes which define a re-writing of a CSS source and CSS variables to change DCSS which is presently used at the mobile terminal 30, and may transmit the messages with the delta to the mobile terminal 30. Alternatively, the server 3 may generate one or several messages which include the CSS that is to be used by the mobile terminal 30.

Alternatively or additionally, the server 3 may output information on the CSS which is to be used by the mobile terminal 30 to a storage 6 for web applications. When a web application is executed by the mobile terminal, the determined CSS may be used, e.g. for a web application programmed using HTML 5.

The mobile terminal 30 may subsequently allow its user to further modify the CSS source and/or CSS variables which were determined by the server 3. The mobile terminal 30 may monitor user input actions which cause the CSS source and/or CSS variables to be re-written. The mobile terminal 30 may provide information on the rewriting of the CSS source and/or the CSS variables to the server 3 which allows the server 3 to further improve the determination of CSS suitable for other mobile terminals having the same hardware configuration as the mobile terminal 30, for example.

While different changes made to the CSS source and/or CSS variables are schematically illustrated in FIG. 1 as changes which affect an optical output interface, the CSS source and/or CSS variables which are re-written in response to a user action may also affect any one or any combination of other device settings, including without limitation wireless interface settings for communication with the cellular communication network, sound interface settings, language settings, power mode settings which define sleep modes or other idle modes, or other parameters of the mobile terminal.

FIG. 2 is a schematic block diagram of a portable electronic device 40 according to an embodiment. The portable electronic device 40 may be configured to interact with the server 3. The portable electronic device 40 may be configured to monitor user input actions received at a user interface 42, to re-write a CSS source and/or CSS variables of dynamic CSS, DCSS, in accordance with the user input action, and to provide information re-writing of the CSS source and/or the CSS variables to the server 3 via a wireless interface 45. The wireless interface 45 is configured for communication with the cellular communication network 7.

The portable electronic device 40 has a processor 41 coupled to the user interface 42. The portable electronic device 40 has a storage device 44 to provide a non-volatile storage, for example. A CSS source and associated CSS variables may be stored in the storage device 44. The processor 41 may use the CSS source and CSS variables for controlling an optical output device, for controlling sound output or sound input, for controlling wireless interface settings, or for other operation parameters of the portable electronic device 40. The CSS may in particular be included in a web application executed by the processor 41. The CSS may be received by the portable electronic device over the wireless interface 45. By using DCSS, setting changes caused by the user input action may cause the CSS source and/or CSS variables of the CSS to be re-written.

The processor 41 may be configured to monitor the changes made to the CSS source and CSS variables in response to user input actions throughout a time interval. Changes in the CSS source and CSS variables which are merely transient changes do not need to be reported to the server 3. For illustration, when a user input action causes merely a temporary change in the CSS source or CSS variables, e.g. because the user adjusts a settings only temporarily, this re-writing of the CSS source and CSS variables does not need to be reported to the server 3.

The processor 41 of the portable electronic device 40 may control the wireless interface 45 to report information on a user-initiated re-writing of the CSS source and/or CSS variables to the server 3. Additional information may be transmitted to the server 3. For illustration, the processor 41 may control the wireless interface 45 to report information on the hardware configuration of the portable electronic device 40 to the server 3. The processor 41 may control the wireless interface 45 to provide information on a manufacturer and device model of the portable electronic device 40 to the server 3. This allows the server 3 to retrieve information on the hardware configuration of the portable electronic device 40 from a Device Description Repository.

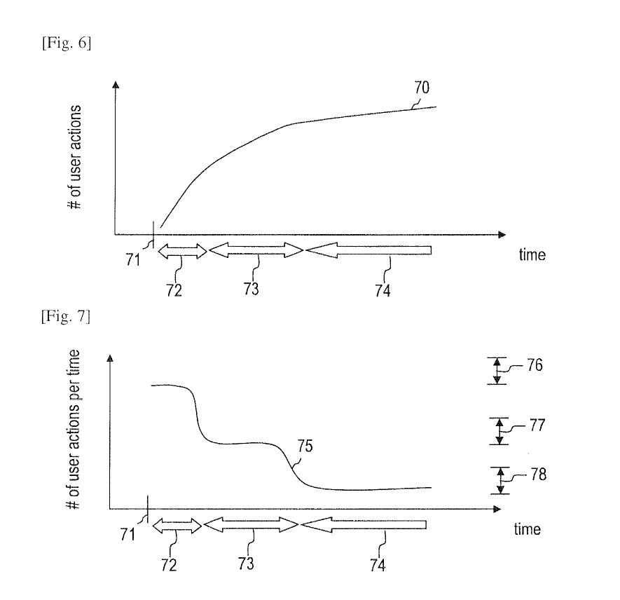

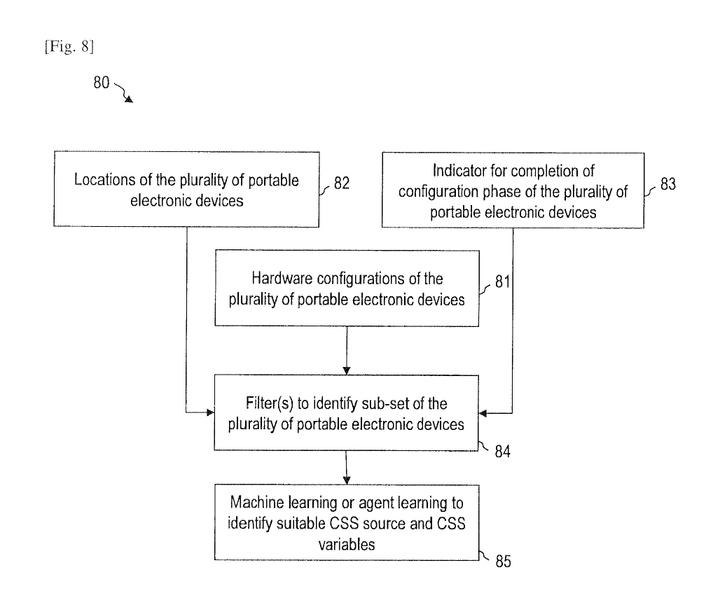

As will be explained in more detail with reference to FIG. 6 and FIG. 7 below, the processor 41 may also monitor to which extent the configuration of the portable electronic device 40 by user input actions has been completed. As an indicator for the completion of the configuration phase, the processor 41 may monitor the number of user input actions which cause the CSS source and/or the CSS variables to be re-written. Information on the number of user input actions per time or the total number of user input actions may be reported to the server 3 or may be used otherwise to indicate to which extent the configuration of the portable electronic device 40 has been completed.

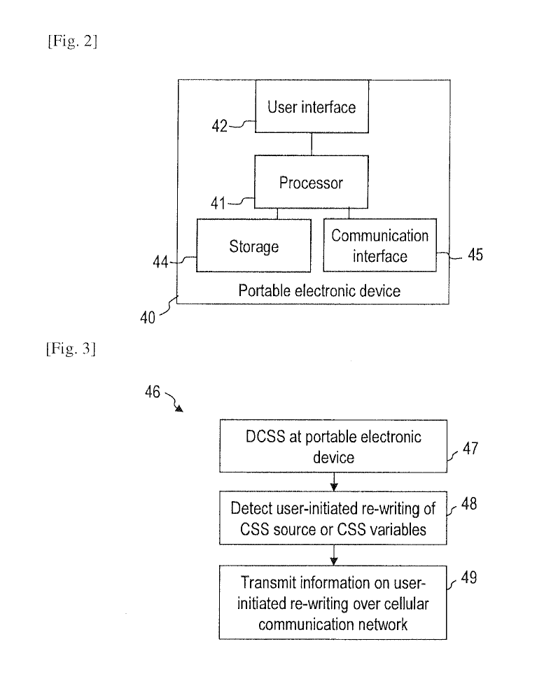

FIG. 3 is a flow chart of a method 46 which may be performed by the portable electronic device 40 according to an embodiment.

At 47, dynamic CSS, DCSS, are used at the portable electronic device. The DCSS may be stored in the portable electronic device. The DCSS may be downloaded from a storage in the wide area network 2. The DCSS allows the CSS source to be re-written. The DCSS allows the CSS variables to be re-written.

At 48, a user-initiated re-writing of the CSS source and/or of CSS variables is detected. The user-initiated re-writing is caused by an user input action which may affect a setting of the portable electronic device, and which triggers a re-writing of the CSS source or of the CSS variables in accordance with the user input action.

At 49, information on the user-initiated re-writing of the CSS source and/or the CSS variables is transmitted to the server 3.

The server 3 uses the information crowdsourced from a plurality of portable electronic devices to identify a CSS source and CSS variables which, for the respective hardware configuration and location, represent a suitable CSS for a mobile terminal.

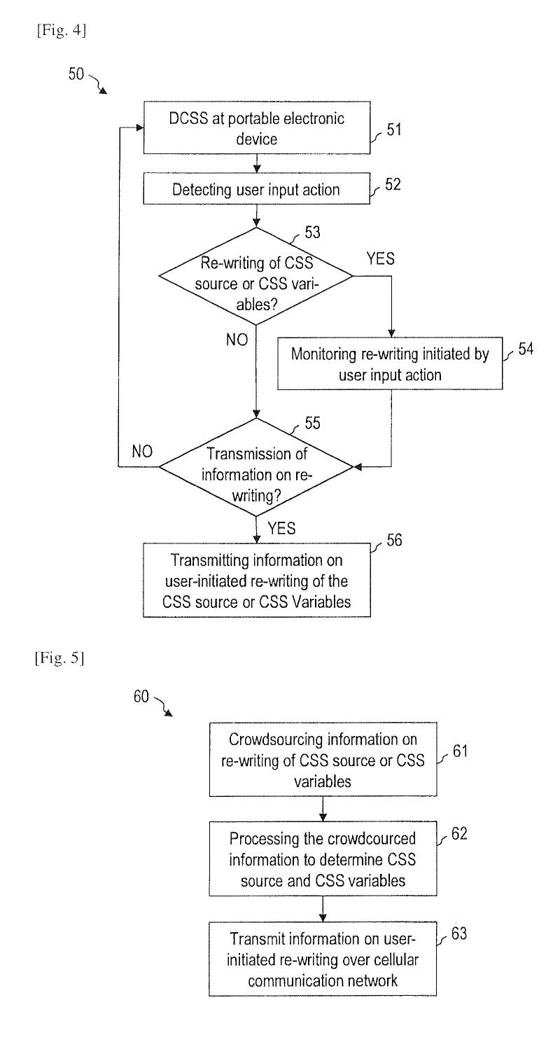

FIG. 4 is a flow chart of a method 50 which may be performed by the portable electronic device 40 according to an embodiment.

At 51, dynamic CSS, DCSS, are used at the portable electronic device. The DCSS may be stored in the portable electronic device. The DCSS may be downloaded from a storage device in the wide area network 2. The DCSS allows the CSS source to be re-written. The DCSS allows CSS variables to be re-written.

At 52, a user input action is detected by the portable electronic device. The user input action may be received at a tactile user interface or a proximity sensitive user interface, for example.

At 53, it is determined whether the user input action causes the CSS source and/or CSS variables to be re-written. The determining at 53 may be based on whether the user input action detected at 52 affects a setting of the portable electronic device which is reflected by a re-writing of the CSS source and/or of the CSS variables. If the user input action does not cause a re-writing of the CSS source or of the CSS variables, the method proceeds to step 55. If the user input action causes a re-writing of the CSS source or of the CSS variables, the method proceeds to step 54.

At step 54, the change in the CSS source and/or in the CSS variables which is caused by the user input action may be monitored. For illustration, a record may be maintained at least temporarily at the portable electronic device which indicates which changes are made to the CSS source and which changes are made to the CSS variables. The method proceeds to step 55.

At step 55, it is determined whether information on the re-writing of the CSS source and/or the CSS variables is to be transmitted. For illustration, the portable electronic device 40 may transmit the information on the re-writing of the CSS source and/or the CSS variables in response to a request from the server 3. The portable electronic device 40 may autonomously determine when the information on the re-writing of the CSS source and/or the CSS variables is transmitted. For illustration, the portable electronic device 40 may determine whether it has monitored the re-writing of the CSS source and/or the CSS variables for a pre-defined time period and may transmit the information on the re-writing of the CSS source and/or the CSS variables at expiry of the pre-defined time period. Alternatively or additionally, the transmission of the information on the re-writing of the CSS source and/or the CSS variables may be triggered when the number of user input actions which cause the CSS source and/or the CSS variables to be re-written reached a pre-defined threshold. If no transmission is required, the method returns to step 51. Otherwise, the method proceeds to step 56.

At step 56, the information on the re-writing of the CSS source and/or of the CSS variables is transmitted to the server 3. The information may define how the CSS source and/or the CSS variables were changed in response to the user action detected at step 52, for example. The information may define how the CSS source and/or the CSS variables were changed compared to the original CSS source and CSS variables.

Additional parameters may be transmitted to the server 3 by the portable electronic device 40. The additional parameters may allow the server 3 to identify a hardware configuration of the portable electronic device 40. The additional parameters may allow the server 3 to identify a location of the portable electronic device 40. The additional parameters may allow the server 3 to establish the stage reached in the configuring phase of the portable electronic device 40.

The server 3 uses the information crowdsourced from a plurality of portable electronic devices to identify a CSS source and CSS variables which, for the respective hardware configuration and location, represent a suitable CSS for a mobile terminal.

FIG. 5 is a flow chart of a method 60 performed by a server 3 according to an embodiment.

At 61, information on a user-initiated re-writing of a CSS source and/or of one or several CSS variables is crowdsourced from a plurality of portable electronic devices. The server may crowdsource the information only from portable electronic devices which agree to share the information on the user-initiated dynamic re-writing of the CSS source and CSS variables.

At 62, the crowdsourced information is processed to determine CSS, i.e. a CSS source and CSS variables, which are to be used by a mobile terminal. The determining step 62 may include a filtering of the crowdsourced information in which some of the portable electronic devices are weighted more strongly in determining the CSS of the mobile terminal than other portable electronic devices. The filter criteria for determining whether the change in the CSS source and CSS variables reported by a portable electronic device are weighted more strongly or less strongly than the changes reported by other portable electronic devices may depend on the hardware configuration, the location or the degree to which a set-up of the respective portable electronic device by the user has already been completed.

Various techniques may be employed by the server to determine the CSS source and CSS variables which are to be used by the mobile terminal. For illustration, the CSS source and CSS variables used by the largest fraction of the portable electronic devices which have the same hardware configuration as the mobile terminal and which operate in the same country as the mobile terminal may be determined as the CSS source and CSS variables for the mobile terminal. In more complex implementations, machine learning or agent based learning may be employed by the server. The server automatically learns rules for selecting a suitable CSS, using the crowdsourced information as input.

At 63, information on the CSS source and CSS variables determined for the mobile terminal are transmitted by the server. The information may be transmitted to the mobile terminal or to a server which stores web applications, for example.

In addition or as an alternative to hardware configuration and location, the identification of the CSS to be used by the mobile terminal may also depend on for how long the portable electronic devices which report information on the re-writing of the CSS source and the CSS variables have already been in use. This may be matched against for how long the mobile terminal 30 has already been in use when it is automatically configured by the server 3. For illustration, shortly after the first start-up of the mobile terminal 30, the user may want to adjust various settings which affect the CSS in a comparatively short time frame. When the mobile terminal 30 has already been in use for an extended time span, the user may not want to adjust the settings of the mobile terminal 30 so frequently any more. Accordingly, the CSS which is optimum for the mobile terminal 30 may vary as a function of whether a user-defined configuration of the mobile terminal 30 has been completed by 0%, by 50%, or to an even larger degree. The same applies to the portable electronic devices 11-22. In order to take into account that the optimum CSS may vary depending on the degree to which the configuration has already been completed, the server 3 may also retrieve information from the portable electronic devices 11-22 which indicates whether the respective portable electronic device is still in an initial configuration phase in which user input actions cause the CSS source and CSS variables to be re-written frequently or whether the CSS source and CSS variables have reached a more steady state in which changes made by the user are rare.

Any suitable indicator may be used by the portable electronic devices 11-22 which reflects whether or not a portable electronic device is still in an early operation phase in which the user causes the CSS source and CSS variables to be re-written frequently. For illustration, the portable electronic device may monitor the number of user input actions per time, or the total number of user actions which occurred since the CSS has been deployed to the user equipment, and which cause the CSS source or at least one CSS variable to be re-written.

FIG. 6 shows an exemplary graph 70 which represents the total number of user actions that occurred from a lime 71 of deployment of the DCSS to the portable electronic device. In a time interval 72, the CSS source or at least one CSS variable is re-written frequently because the user tends to make adjustments in early operation stages. In a transition interval 72, the rate of user input actions which cause the CSS source or at least one CSS variable to be re-written decreases. The total number of user input actions which cause the CSS source or at least one CSS variable to be re-written increases less rapidly. In a time interval 73, the number of user input actions which cause the CSS source or at least one CSS variable to be re-written changes slowly because the user has made most settings be intended to make to the configuration of the portable electronic device.

FIG. 7 shows an exemplary graph 75 which represents the number of user actions per time interval which cause the CSS source or at least one CSS variable to be re-written. In the time interval 72, the rate at which the CSS source or at least one CSS variable is re-written is fairly large. In the transition interval 72, the rate at which the CSS source or at least one CSS variable is re-written decreases. In the interval 73, the configuration has reached a steady state and the rate of user actions which cause the CSS source or at least one CSS variable to be re-written approaches zero.

The portable electronic device may monitor the rate at which user input actions cause the CSS source or at least one CSS variable to be re-written. For illustration, the portable electronic device may compute a floating time average of the number of user actions which cause the re-writing of the CSS source of at least one CSS variable. The portable electronic device may determine in which one of several intervals 76, 77, 78 the floating time average is included, and may send this information to the server 3 to indicate in which stage of user-defined configuration changes the respective portable electronic device is.

It will be appreciated that other indicators may be used by the portable electronic devices which allow the server 3 to establish to which extent the user-defined configuration changes made on the respective portable electronic device have converged.

FIG. 8 is a functional block diagram 80 of a server according to an embodiment. The various functions may be performed by the processing device 5 of the server 3.

The server 3 may have a module 81 for retrieving information on the hardware configurations of the plurality of portable electronic devices from which the information on the re-writing of the CSS source and/or at least one CSS variable are retrieved. The module 81 may retrieve the information on the hardware configuration from report messages transmitted by the plurality of portable electronic devices to report the changes in CSS source and/or CSS variables. The module 81 may access a database, using device identifiers of the plurality of portable electronic devices, to respectively retrieve information on the hardware configurations.

The server 3 may have a module 82 for retrieving location information for each one or at least some of the plurality of portable electronic devices. The module 82 may retrieve the location information from configuration from report messages transmitted by the plurality of portable electronic devices to report the changes in CSS source and/or CSS variables. The module 82 may retrieve the location information from a node of the cellular communication network 7. The location information may include at least information on a country, e.g. a mobile country code, MCC, or a public land mobile network, PLMN, identifier.

The server 3 may have a module 83 or receiving an indicator which represents to which extent the configuration phase of the respective portable electronic device has been completed. The indicator may reflect a rate of user actions which cause the CSS source or CSS variables to be re-written, as explained with reference to FIG. 6 and FIG. 7. The module 83 may retrieve the indicator from report messages transmitted by the plurality of portable electronic devices to report the changes in CSS source and/or CSS variables.

The server may have a filter module 84 which performs a filtering based on one or several of the hardware configuration, the location, or the indicator for the degree to which the configuration phase of the plurality of electronic devices has been completed. The filter module 84 may select a sub-set of portable electronic devices which have the same hardware configuration and which operate in the same country as the mobile terminal 30, for example. The filter module 84 may weight information received from portable electronic devices which have the same hardware configuration and which are used in the same country as the mobile terminal 30 more strongly than the information received from other portable electronic devices when determining the CSS source and CSS variables for the mobile terminal.

The server may have learning module 85 which uses the information on the rewriting of the CSS source and/or the CSS variables crowdsourced from at least the devices identified by the filter module 84 as input. The learning module 85 may implement a machine learning or an agent based learning. In response to receiving information on the hardware configuration of the mobile terminal and the country in which the mobile terminal is used, the learning module 85 determines the CSS source and CSS variables which would be suitable for the mobile terminal. Other parameters characterizing the mobile terminal may also be taken into account, e.g. the degree to which a configuration phase has already been completed at the mobile terminal by manual user input.

Various effects are attained by the devices and methods according to embodiments. For illustration, the CSS source and CSS variables suitable for a mobile terminal may be determined automatically by crowdsourcing and processing information on user-initiated changes made to a CSS source and CSS variables. By using DCSS which allows the CSS source to be re-written and CSS variables to be changed, the users of the portable electronic devices are allowed to effect changes in the CSS of their respective portable electronic device. This information is utilized when the mobile terminal is to be used in the system as a new device, for example, to find CSS which are suitable and which may even be optimum for the respective mobile terminal.

While exemplary embodiments have been described with reference to the drawings, modifications may be implemented in other embodiments. For illustration, the mobile terminal may be a mobile phone, a portable computer, or another terminal.

For further illustration, the server may also identify more than one suitable configuration for the mobile terminal. Similarly to an optimization problem with constraints, there may be various implementations of the CSS source and of the CSS variables which are identified as being suitable for the mobile terminal using the techniques disclosed herein.

Further, while exemplary network technologies have been described, embodiments of the invention may be used in combination with other network technologies.

The operation of the various functional units may be implemented by hardware, by software, or a combination thereof. For illustration, the functions of the logic which determines the CSS to be used by the mobile terminal may be performed by a microprocessor or microcontroller which executes instructions programmed in a non-volatile memory.

1. A method of configuring a mobile terminal, comprising:
monitoring, by each one of a plurality of portable electronic devices, a user-initiated re-writing of a Cascading Style Sheets, CSS, source and/or of at least one CSS variable,
crowdsourcing, by a server, information on the user-initiated re-writing from the plurality of portable electronic devices through a cellular communication network,
processing, by the server, the crowdsourced information on the user-initiated rewriting to determine CSS to be used by the mobile terminal, and
outputting, by the server, information on the determined CSS to configure the mobile terminal.

2. The method of claim 1, further comprising:
identifying a sub-set of portable electronic devices in the plurality of portable electronic devices by comparing at least hardware configurations of the plurality of portable electronic devices to a hardware configuration of the mobile terminal,
wherein the server uses only the crowdsourced information on the user-initiated re-writing from the sub-set of portable electronic devices to determine the CSS to be used by the mobile terminal.

3. The method of claim 2, wherein identifying the sub-set of portable electronic devices comprises at least one of:
comparing a processor configuration of the plurality of portable electronic devices to a processor configuration of the mobile terminal,
comparing a memory configuration of the plurality of portable electronic devices to a memory configuration of the mobile terminal, or
comparing a wireless interface configuration of the plurality of portable electronic devices to a wireless interface configuration of the mobile terminal.

4. The method of claim 2,
wherein identifying the sub-set of portable electronic devices comprises a location-based filtering.

5. The method of claim 2,
wherein identifying the sub-set of portable electronic devices comprises a filtering in dependence on a number of user input actions which cause the user-initiated re-writing of the CSS source and/or of the at least one CSS variable to be performed.

6. The method of claim 1,
wherein monitoring the user-initiated re-writing of the CSS source and/or of the at least one CSS variable comprises monitoring user input actions received at a user interface from a user which cause the CSS source to be re-written.

7. The method of claim 1, comprising:
generating, by the server, at least one message based on the determined CSS and transmitting the at least one message to at least one of the mobile terminal or a web server for executing a web application using the determined CSS.

8. The method of claim 1,
wherein the server uses the crowdsourced information on the user-initiated re-writing as input for a machine learning or an agent based learning to determine the CSS to be used by the mobile terminal.

9. A portable electronic device, comprising:
a user interface,
a communication interface configured for communication with a cellular communication network,
a processor coupled to the user interface and the communication interface, the processor being configured
to perform a re-writing of a Cascading Style Sheets, CSS, source and/or of at least one CSS variable in accordance with a user input action detected by the user interface, and
to control the communication interface to report information on the user-initiated re-writing to a server over the cellular communication network.

10. The portable electronic device of claim 9,
wherein the processor is configured to monitor the re-writing of the CSS source and/or of the at least one CSS variable throughout a time interval prior to reporting the information to the server.

11. The portable electronic device of claim 10,
wherein the processor is configured
to generate an indicator for a number of user input actions throughout the time interval which cause the CSS source and/or the at least one CSS variable to be re-written, and
to control the communication interface such that the information includes the indicator.

12. The portable electronic device of claim 9,
wherein the processor is configured to use the CSS source and the at least one CSS variable for controlling the user interface and/or the communication interface when a web application is executed.

13. A server, comprising:
an interface configured for communication with a cellular communication network, and
a processing device coupled to the interface and configured to:
crowdsource information on a user-initiated re-writing of a Cascading Style Sheets, CSS, source and/or of at least one CSS variable from a plurality of portable electronic devices connected to the cellular communication network,
process the crowdsourced information on the user-initiated re-writing to determine CSS to be used by a mobile terminal, and
provide information on the determined CSS to the mobile terminal through the interface to configure the mobile terminal.

14. The server of claim 13,
wherein the processing device is configured to identify a sub-set of portable electronic devices in the plurality of portable electronic devices by comparing at least hardware configurations of the plurality of portable electronic devices to a hardware configuration of the mobile terminal, and
wherein the processing device is configured to use only the crowdsourced information on the user-initiated re-writing from the sub-set of portable electronic devices to determine the CSS to be used by the mobile terminal.

15. A communication system, comprising:
a plurality of portable electronic devices of claim 9, and a server.
